(19) United States
(12) Patent Application Publication
(10) Pub. No.: US 2007/0036288 A1
(43) Pub. Date: Feb. 15, 2007

(54) Personalized telephone number

(75) Inventor: Prashant Shashikant Parikh, Naperville, IL (US)

Correspondence Address: DOCKET ADMINISTRATOR;LUCENT TECHNOLOGIES INC., ROOM 2F-190, 600 MOUNTAIN AVENUE, MURRAY HILL, NJ, 07974-0636, US

(73) Assignee: Lucent Technologies Inc.

(21) Appl. No.: 11/183,669

(22) Filed: Jul. 18, 2005

(51) Int. Cl. H04M 1/64

(52) U.S. Cl. 379/88.02

(57) ABSTRACT

A method and apparatus for establishing telephone connections to a called party which has been assigned a personalized number as well as a “plain old telephone service” (POTS) number. A caller dials directing information to indicate that a personalized number and not a POTS number is being supplied by the caller. A database system for serving a switch having intelligent network capabilities translates from that personalized number to the POTS number assigned to the called party. The public switched telephone network, using that POTS number, establishes a connection between the caller and the called party in accordance with the principles of the prior art. If the caller is not connected to a switch having intelligent network capabilities, the caller dials a directing code to access a switch having intelligent network capabilities and the latter switch accesses the database system to translate from the personalized number to the POTS number. Advantageously, any destination telephone can be assigned a personalized number and calls to that personalized number can charged to the caller. Advantageously, personalized numbers are much easier to remember than POTS numbers.

### TECHNICAL FIELD

This invention relates to a method and apparatus for providing telephone customers with variable length personalized telephone numbers.

### BACKGROUND OF THE INVENTION

A major innovation in telephony was the introduction of 800 telephone numbers. These numbers had the characteristic that they were not tied to specific geographic locations and, as a matter of fact, could serve the entire country. As 800 service grew more popular, companies tried to obtain telephone numbers which represented the company or a service. For example, the Automobile Association of America has a nationwide telephone number, AAA-HELP, which can be used for summoning emergency road service.

Outside the field of direct telephony, the Internet, which uses alphanumeric keyboards, allows users to specify, for example, an e-mail address which can contain their name plus enough additional information to distinguish them from other users.

### SUMMARY OF THE INVENTION

Applicant has carefully studied these plans and has recognized their significant limitations. 800 type service is limited to the service wherein the called party pays for the telephone charges. It is further limited to one of a number of prefixes (e.g., 800, 888, 877 . . . ) and a standard length 7 digit number (although additional numbers ignored by the telephone system can be dialed for identification purposes).

While the name arrangement for the Internet e-mail service is extremely flexible, it requires an alphanumeric keyboard and cannot be directly applied to ordinary telephone calls.

These problems are solved and an advance is made over the prior art in accordance with Applicant's invention wherein individual telephone users or businesses which do not wish to absorb the cost of incoming calls are assigned a variable length number; in most cases, this is a number whose telephone key digits correspond to some meaningful word(s) such as a name, possibly augmented by additional numbers to distinguish from other users wishing to use the same name or a name which happens to correspond to the same telephone key digits. This variable length name is then translated into a POTS (Plain Old Telephone Service) telephone number and that number is used by the public switched telephone network to route the call in conformance with the principles of the prior telephone art. Advantageously, any telephone user can be assigned any telephone number of any length which makes it easier to remember the assigned number.

In accordance with one feature of Applicant's invention, if the caller is served by a switch having intelligent network capabilities, the caller dials a brief prefix such as *88 before dialing the personalized number of the destination. If the caller is served by a switch which does not have intelligent network capabilities, the caller dials an access number such as 1-800-346-36263 (equals 1 800 FIND NAME) to route the call to a switch having intelligent network capabilities. The switch having intelligent network capabilities then receives the dialed personalized number and accesses a database (DB) to translate from the personalized number to the POTS number of the dialed destination. Advantageously, both types of switches can then serve customers who wish to dial a personalized number. A variety of systems can be employed by a 1-800-FIND NAME server to recognize the personalized number that includes dialed digits (DTMF (dual tone multi-frequency) or rotary), voice recognition, etc. In addition, the DB can be accessed using internet and the user can have a smart phone (or just do it in two steps) that makes the data query to get the POTS number from the personalized number and dials the POTS number thereafter.

In the Internet Protocol (IP) world, the caller can do the same as above or the service provider can set up their Domain Name Server (DNS) to resolve the number (e.g., FLOWERS@FINDNAME.ORG).

In accordance with another feature of Applicant's invention, the personalized numbers exist in parallel with the POTS numbers so that a customer can also dial the POTS number of a destination in order to reach that destination.

In accordance with another feature of Applicant's invention, there is a delimiter to indicate the end of the string of digits representing the personalized number. In Applicant's preferred embodiment, this end symbol is a # (“pound”) sign. Advantageously, the use of an end symbol avoids the necessity for having a timeout to detect the end of dialing.

### BRIEF DESCIRPTION OF THE DRAWING(S)

FIG. 1 is a block diagram illustrating the operation of Applicant's invention;

FIG. 2 is a diagram illustrating the database contents required to implement Applicant's invention; and

FIG. 3 is a flow diagram illustrating the method of Applicant's invention.

### DETAILED DESCRIPTION

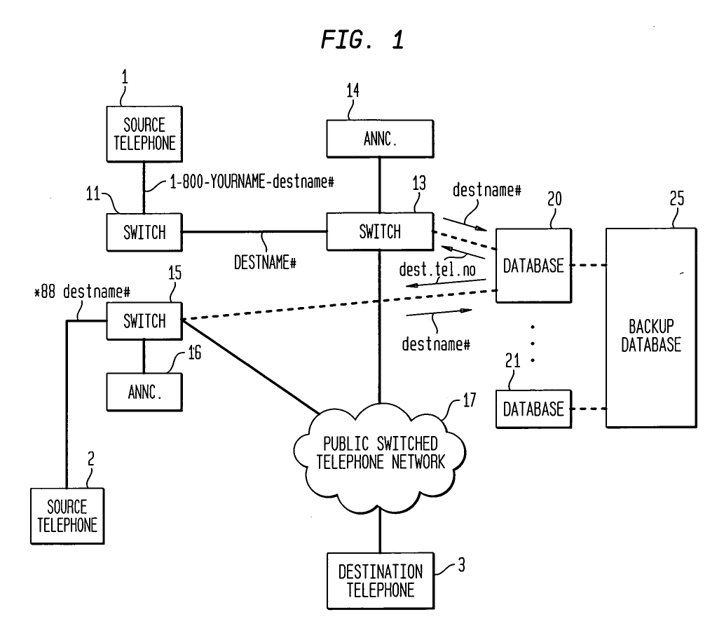

FIG. 1 is a block diagram illustrating the operation of Applicant's invention. FIG. 1 shows two source telephones, telephone 1 and telephone 2. Source telephone 1 is served by switch 11 which does not have intelligent network capabilities. Switch 11 is connected to switch 13 which does have intelligent network capabilities. A customer at source telephone 1 dials 1-800-FIND NAME. The switch 13 connects the call to a media server which prompts user to enter the personal number and a delimiter, in this case a # sign. The switch 13 accesses database 20 in order to obtain the POTS telephone number of destination telephone 3, the telephone which source telephone 1 is trying to reach. The database 20 replies with this POTS destination telephone number and switch 13 then accesses the destination telephone 3 via the public switched telephone network 17.

Also shown is source telephone 2 served by switch 15 which has intelligent network capabilities. Source telephone 2 in this case dials an abbreviated directing code such as *88 followed by the destination name and # sign. Switch 15 uses the destination name to query database 20 and to receive from database 20 a response specifying the POTS telephone number of the destination telephone 3. Switch 15 then sends the call via public switched telephone network 17 to destination telephone 3.

If desired, an announcement machine 14 or 16 can be attached to switch 13 or 15, respectively, to announce to the caller that a connection is being requested which is a toll connection and that the caller will incur toll charges. The announcement machine can also present announcements relating to faulty destination name queries.

FIG. 1 shows one diagram for accessing a database to obtain the POTS number. A plurality of databases 20, . . . ,21 are provided for storing the data of a large number of personalized numbers. In addition, a large backup database 25 is provided which stores all of the personalized number translation. Either the switch accessing the database or one of the databases will contain information for identifying the database that actually stores the personalized number to POTS number translation for the particular dialed personalized number.

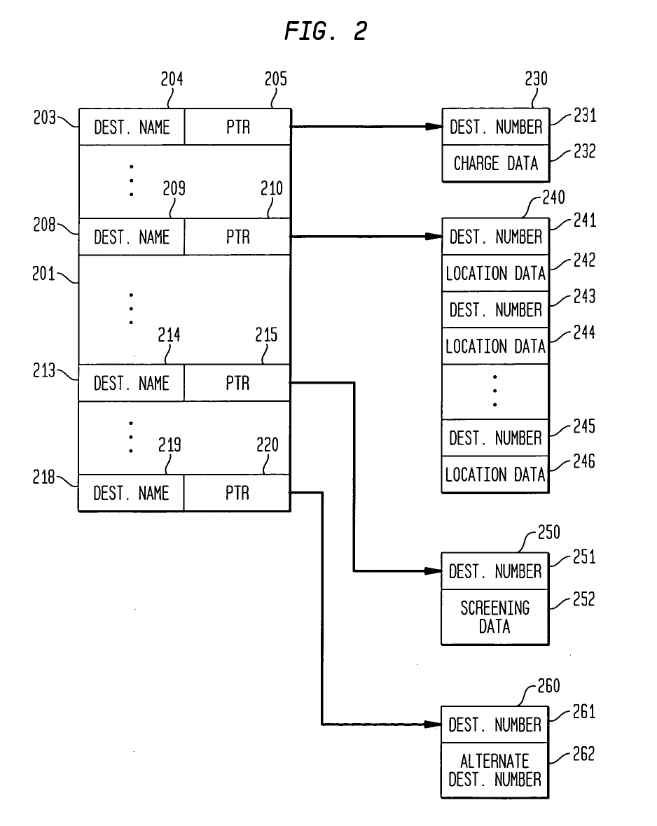

FIG. 2 is a data layout of the contents of one of the databases 20, . . . ,21, 25. A head table 201 contains a table of the destination names served by the database and for each destination name a pointer is indicated. Thus, for entry 203, destination name 204 corresponds to pointer 205 which points to block 230. For entry 208, destination name 209 corresponds to pointer 210 which points to block 240. For block 213, destination 214 corresponds to pointer 215 which points to block 250. And finally, for block 218, destination name 219 corresponds to pointer 220 which points to block 260.

Block 230 is for the simple case in which one destination name corresponds to one destination number 231. In addition, entry 232 contains charge data such as an indication that this is a toll call or an indication that this is a toll free call. Either of these two indications can lead to an announcement to the caller to inform the caller of this special type of charge.

Block 240 contains a series of destination numbers 241, 243, . . . ,245 each of which corresponds to a different geographic location 241, 242, 244, . . . ,246. The location data may be a series of area codes or office codes or both, or it may be a geographic coordinate to be used in case the caller is a cellular station. The object is to connect the caller to the nearest appropriate destination such as the nearest Pizza Hut restaurant.

Block 250 shows a destination number 251 and screening data 252. Screening data can be data to block calls from specific calling numbers or to block calls from all but a series of such numbers.

Finally, block 260 contains a primary destination number 261 and an alternate destination number 262 to be used, for example, in case the station indicated by destination number 261 is busy; alternatively, both the station number indicated in 261 and the station number indicated in 262 can be simultaneously alerted using the principles of flexible alerting in which several stations are simultaneously alerted and the call is completed to the first one to answer.

The examples of blocks 230, 240, 250 and 260 are only some of the possible services that can be provided in response to a caller calling a destination name. In general, any service which can be triggered by a caller calling a conventional (i.e., area code, office code, 4 digit number) can be triggered using the principles of this invention.

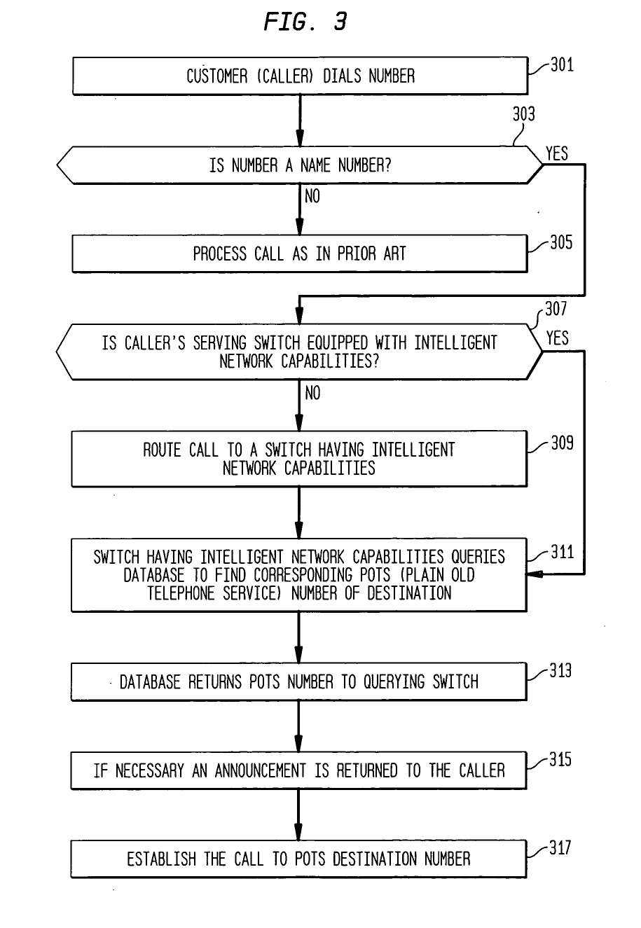

FIG. 3 is a flow diagram illustrating the method of Applicant's invention. A customer (caller) dials a number (action block 301). The connected serving switch determines whether the number is a name number (test 303). If not, the call is processed as in the prior art (action block 305). If the dialed number is a name number, the switch tests whether it is equipped with Intelligent Network capabilities (test 307). If so, action block 309 is by-passed and action block 311 is entered. If not, the call is routed to a switch having Intelligent Network capabilities (action block 309) and action block 311 is entered. In action block 311, the switch having intelligent network capabilities queries a database to find a POTS (Plain Old Telephone Service) number of the destination, corresponding to the dialed name number. The database responds with a POTS number (action block 313). If necessary, for example, if the call is a toll call, an announcement is returned to the caller (action block 315). The call is established to the POTS destination number (action block 317).

The above description is of one preferred embodiment of Applicant's invention. Other embodiments will be apparent to those of ordinary skill in the art without departing from the scope of the invention. The invention is limited only by the attached claims.

I claim:

1. A method of establishing a telephone connection, comprising the steps of:
assigning to a destination telephone, a personalized telephone number;
from a calling station, accessing a switch having intelligent network capabilities;
transmitting said personalized telephone number to said switch having intelligent network capabilities;
accessing a database, from said switch having intelligent network capabilities, to translate between said personalized telephone number and a POTS (Plain Old Telephone Service) telephone number of a called destination station; and
establishing a connection over the public switched telephone network between said switch having intelligent network capabilities and said called destination station identified by said POTS telephone number.

2. The method of claim 1 wherein the step of establishing a connection to said switch having intelligent network capabilities, comprises the steps of:
connecting said calling station to a switch serving said calling station, the serving switch not having intelligent network capabilities;
dialing a directing code to said serving switch not having intelligent network capabilities; and
using said directing code, connecting said calling station via said serving switch not having intelligent network capabilities to another switch having intelligent network capabilities.

3. The method of claim 1 wherein the step of accessing a switch having intelligent network capabilities, comprises the steps of:
connecting said calling station to a serving switch having intelligent network capabilities; and
from said calling station, dialing a directing code preceding said personalized telephone number, said directing code for indicating a personalized telephone number.

4. The method of claim 1 further comprising the steps of:
establishing a connection between another calling station and said called destination station wherein said another calling station dials said POTS number and does not dial said personalized number.

5. The method of claim 1 further comprising the step of:
providing charge indications to said calling station for said connection.

6. The method of claim 1 wherein the step of translating between said personalized telephone number and a POTS telephone number comprises the step of:
accessing geographic data to determine which of a plurality of telephone numbers of called destination stations should be used for said telephone connection.

7. The method of claim 1 wherein the step of translating comprises the step of:
accessing screening data to determine whether a call from said calling station to said destination telephone should be completed.

8. The method of claim 1 wherein the step of translating comprises the step of:
translating to find a plurality of telephone numbers of possible called destination stations for said connection.

9. The method of claim 8 wherein said plurality comprises a plurality of telephone numbers for a flexible alerting call.

10. The method of claim 8 wherein said plurality of telephone numbers comprises a primary number and at least one alternate number for use in case a connection to said primary number cannot be established.

11. Apparatus for establishing a telephone connection, comprising:
means for assigning to a destination telephone, a personalized telephone number;
means for accessing a switch having intelligent network capabilities from a calling station;
means for transmitting said personalized telephone number from said calling station to said switch having intelligent network capabilities;
means for accessing a database from said switch having intelligent network capabilities, to translate between said personalized telephone number and a plain old telephone service (POTS) telephone number of a called destination station; and
means for establishing a connection over the public switched telephone network between said switch having intelligent network capabilities and said called destination station identified by said POTS telephone number.

12. The apparatus of claim 11 wherein the step of establishing a connection to said switch having intelligent network capabilities, comprises:
means for connecting said calling station to a switch serving said calling station, the serving switch not having intelligent network capabilities;
said serving switch not having intelligent network capabilities comprising means for accepting a dialed directing code; and
means, responsive to receiving said directing code, for connecting said calling station via said serving switch not having intelligent network capabilities to a switch having intelligent network capabilities.

13. The apparatus of claim 11 wherein the means for accessing a switch having intelligent network capabilities, comprises:
means for connecting said calling station to a serving switch having intelligent network capabilities; and
means for accepting a directing code preceding said personalized telephone number, said directing code for indicating a personalized telephone number.

14. The apparatus of claim 11 further comprising:
means for establishing a connection between another calling station and said called destination station wherein said another calling station dials said POTS number and does not dial said personalized number.

15. The apparatus of claim 11 further comprising:
means for providing charge indications to said calling station for said connection.

16. The apparatus of claim 11 wherein the means for translating between said personalized telephone number and a POTS telephone number comprises:
means for accessing geographic data to determine which of a plurality of telephone numbers of a called station should be used for a connection to a called station.

17. The apparatus of claim 11 wherein the means for translating comprises:
means for accessing screening data to determine whether a call from said calling station to said called destination telephone should be completed.

18. The apparatus of claim 11 wherein the means for translating comprises:
means for translating to find a plurality of telephone numbers of possible called destination stations for said connection.

19. The apparatus of claim 18 wherein said plurality comprises a plurality of telephone numbers for a flexible alerting call.

20. The apparatus of claim 18 wherein said plurality of telephone numbers comprises a primary number and at least one alternate number for use in case a connection to said primary number cannot be established.
